(19) United States
(12) Patent Application Publication
(10) Pub. No.: US 2026/0064894 A1
(43) Pub. Date: Mar. 5, 2026

(54) COMMUNICATION FILTERING TECHNOLOGIES

(71) Applicant: Intel Corporation, Santa Clara, CA (US)

(72) Inventors: Samuel HUI, Hillsboro, OR (US); Jayant MANGALAMPALLI, Corcoran, MN (US); Ching Yu LO, Portland, OR (US); Krzysztof TREDER, Gdansk (PL)

(21) Appl. No.: 19/380,374

(22) Filed: Nov. 5, 2025

(51) Int. Cl. G06F 21/85; G06F 21/55; G06F 21/57

(52) U.S. Cl. CPC G06F 21/85; G06F 21/554; G06F 21/577

(57) ABSTRACT

Examples described herein relate to: an interface and circuitry to: monitor a bus for a particular message and based on detection of the particular message, replace the particular message with an invalid portion and provide the invalid portion to a receiver, wherein the particular message comprises a command and wherein the receiver comprises an Embedded Multi-Media Card (eMMC). In some examples, the circuitry comprises a platform root of trust (PRoT), a management controller, a multiplexer, or a host system.

### DESCRIPTION

Open Compute Project Secure Firmware Recovery standard version 1.0 (2022) prescribes that server platforms securely update and recover increasing numbers of platform devices. Platform updates include updates of Integrated Firmware Image (IFWI) for platform partitions, management controller firmware, graphics processing unit (GPU) firmware, firmware for Peripheral Component Interconnect Express (PCIe) cards, and others. However, Serial Peripheral Interface (SPI) flash memory capacity is limited and may not be able to store firmware for the devices.

### BRIEF DESCRIPTION OF THE DRAWINGS

FIG. 1 depicts an example system.

FIGS. 2, 3, and 4 show examples of communications.

FIG. 5 depicts an example of command token components.

FIG. 6 depicts an example system.

FIG. 7 depicts an example operation.

FIG. 8 depicts an example process.

FIG. 9 depicts an example system.

### DETAILED DESCRIPTION

Storage devices that support a higher capacity than SPI flash include Embedded Multi-Media Card (eMMC), or other protocols. However, some accesses to storage devices can attempt to modify contents of firmware for purposes of gaining unauthorized access to devices or device data or causing devices to malfunction. Various examples can utilize circuitry to monitor for unpermitted accesses to firmware storage devices by determining whether a message includes a command that is permitted or not permitted and based on the command not being permitted, inject an intentionally invalid integrity value into the message to cause the command to be rejected so that tampering with the firmware storage can be avoided.

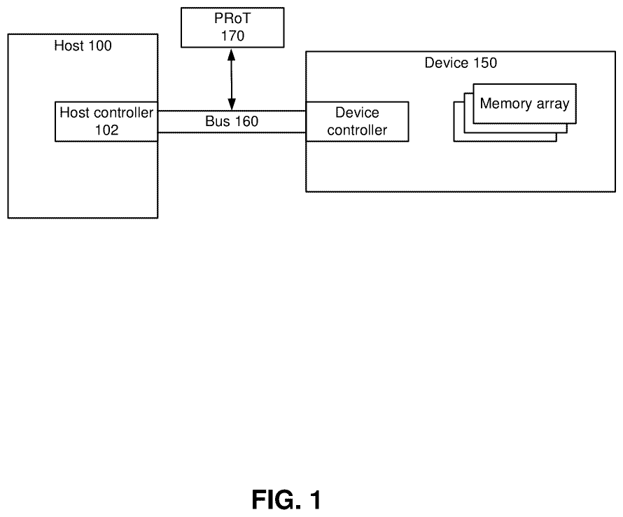

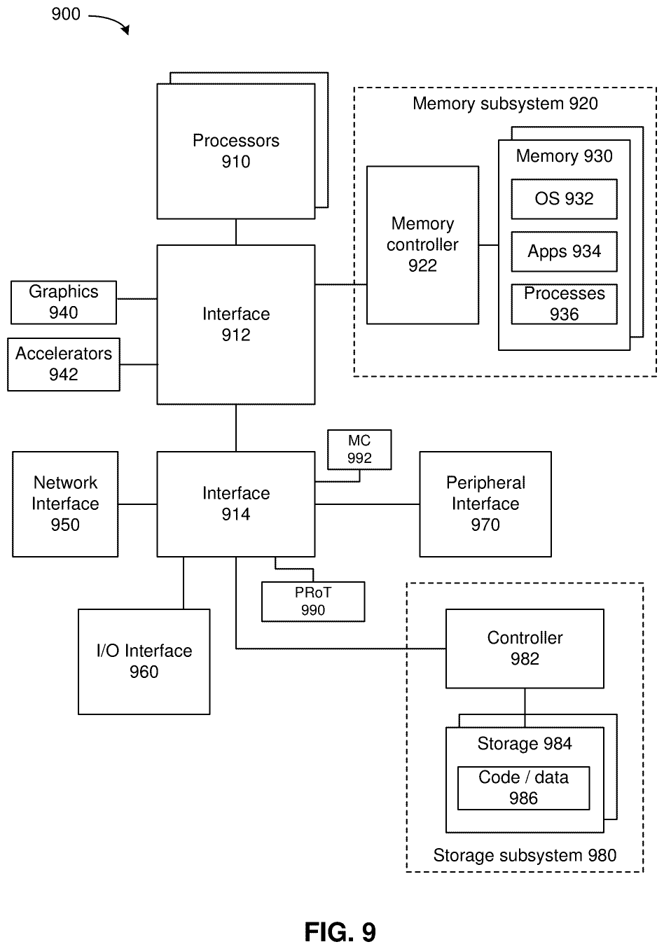

FIG. 1 depicts an example system. Host 100 can include processors, memory, host controller 102, and other circuitry and software described at least with respect to FIG. 9. Host controller 102 can transmit signals to device 150 and receive signals from device 150. Host controller 102 can transmit signals via clock (CLK), command (CMD), and data lines to device 150. During a clock cycle, host controller 102 can direct 1-bit transfer on CMD lines and 1 or 2-bit transfer on data lines. CMD lines can be bi-directional and used for transfer of commands from host 100 to device 150 and responses from device 150 to host 100. Data (e.g., DAT0-DAT7) can be bi-directional and used for data transfer from host 100 to device 150 or from device 150 to host 100. Various data transmission modes can be supported such as 1-bit, 4-bit, or 8-bit modes. Other numbers of lines and sizes of bit transfers can be used.

In some examples, eMMC Bus Protocol (e.g., Embedded Multi-Media Card (eMMC) Electrical Standard (5.1) (JESD84-B51) (2015) as well as earlier versions, later versions, and variations thereof) can be utilized to transmit data between host 100 and device 150. eMMC messages can be represented by tokens command, response, and data. The command token can start an operation and be sent by host 100 serially on a CMD line to device 150. A response from device 150 can include an answer to a received command and be sent by device 150 serially on the CMD line. Data strobe can be host controlled and used for eMMC HS400 400 MB/s data transfer mode.

According to some examples, Platform Root of Trust (PRoT) 170 can be connected to bus 160 to monitor command tokens from host 100 to device 150. PRoT 170 reads command tokens from bus 160 to determine whether command is permitted to be executed by device 150 or not permitted to be executed by device 150. As described herein, PRoT 170 can monitor and filter communications on bus 160 to detect and potentially block operations that are not configured as permitted (e.g., disallowed operations, erase operations to certain addresses in a memory or storage device of device 150, or others). As described herein, based on determination by PRoT 170 that a command is to be blocked (e.g., disallowed operations, writes to specific memory regions, or others), PRoT 170 can disconnect host 100 from bus 160 before host 100 sends a command token integrity check value (e.g., (cyclic redundancy check (CRC) value or hash value) to device 150. Instead, PRoT 170 can calculate and inject an intentionally invalid integrity check value on bus 160 to device 150, which causes device 150 to fail the integrity check value for the command and device 150 does not execute the command. Under the eMMC bus protocol, based on the CRC check failing, the eMMC device does not respond to the associated command, and does not execute the command.

In some examples, PRoT 170 can be consistent with National Institute of Standards and Technology (NIST) SP 800-193 guidance for platform firmware resiliency against potentially destructive attacks. One guidance is platform firmware code and critical data are to remain in a state of integrity and are protected from corruption, such as the process for ensuring the authenticity and integrity of firmware updates. Another guidance is detection of platform firmware code and critical data corruption is to occur. Another guidance is restoring platform firmware code and critical data to a state of integrity in the event corruption occurs.

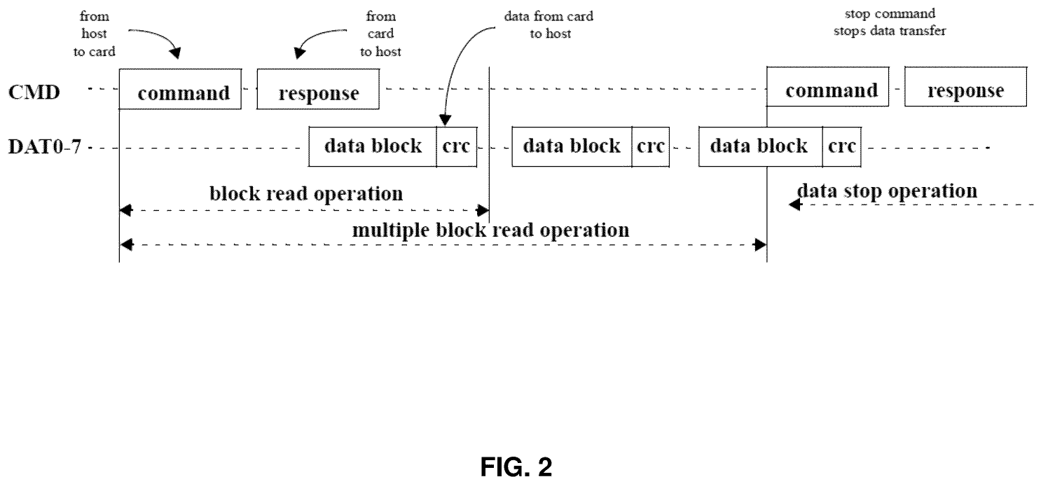

FIGS. 2, 3, and 4 show examples of tokens of various eMMC operations. FIG. 2 depicts an example of read command and response semantics. A host can transmit a command to device (e.g., card) on CMD line to indicate a data read operation and receive a response to the command from the device on the CMD line. The device can provide to the host: a first data block with an integrity check value on the DATA lines, followed by any number of data blocks. The host can transmit a command to the device on the CMD line indicating a data read stop operation to indicate data read will conclude for the current data read command.

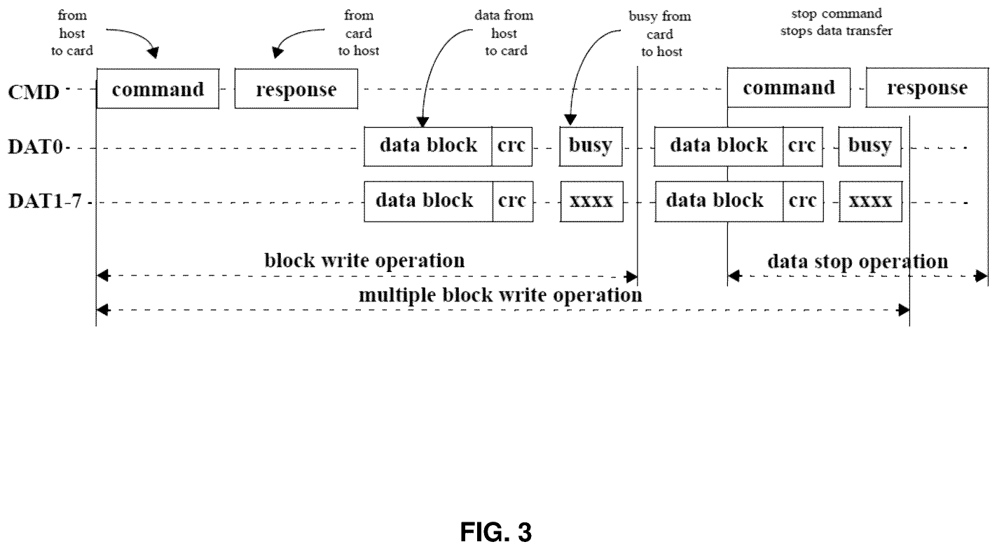

FIG. 3 depicts an example of write command and response semantics. A host can transmit a command to device (e.g., card) on CMD line to indicate a data write operation and receive a response to the command from the device on the CMD line. The host can provide to the device: a first data block with an integrity check value on the DATA lines, followed by a second data block. The device can indicate to the host that the device is unable to receive data by transmitting a busy response. The host can transmit a command to the device on the CMD line indicating a data write stop operation to indicate data write will conclude for the current data write command.

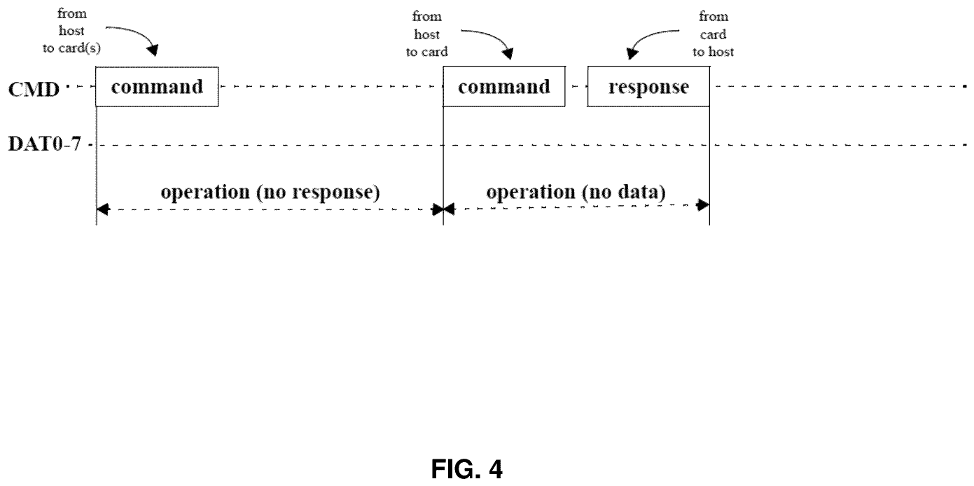

FIG. 4 depicts an example of semantics. For example, the host can transmit a command to a device but the device does not transmit a response to the host. For example, the host can transmit a command to a device and the device transmits a response to the host.

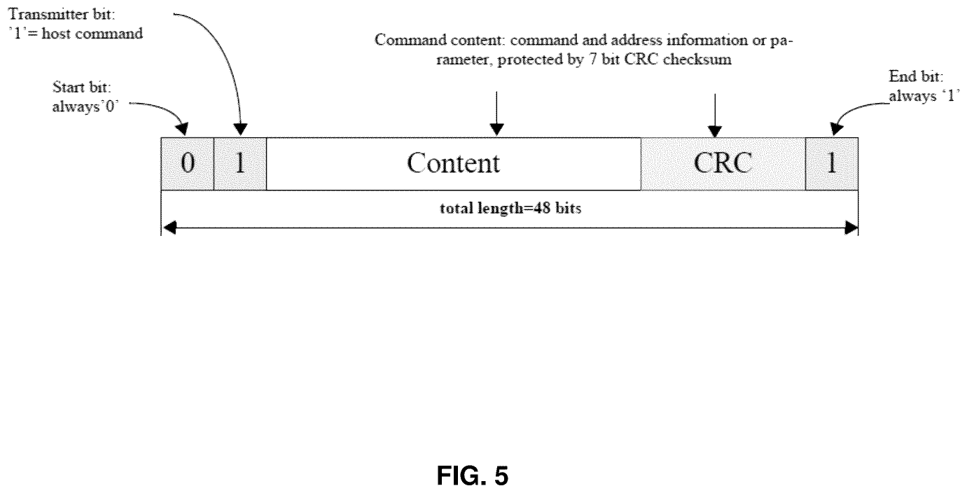

FIG. 5 depicts an example of command token components. For example, a command can include a start bit, a command bit (e.g., 1 bit for transmit), command content, and an integrity check value (e.g., CRC) calculated on the content, and an end bit. Content can include a 6-bit Command Index and 32-bit Command Argument. For example, for the READ_MULTIPLE_BLOCK command: Command Index can be set to 18 (0b010010), Command Arguments [31:0] can indicate data address to read from. The integrity check value can be 7-bits and can be used for detecting errors in the command. As described herein, a monitor device that identifies a command as invalid can modify an integrity check value to an invalid value to disable execution of commands by a receiver device.

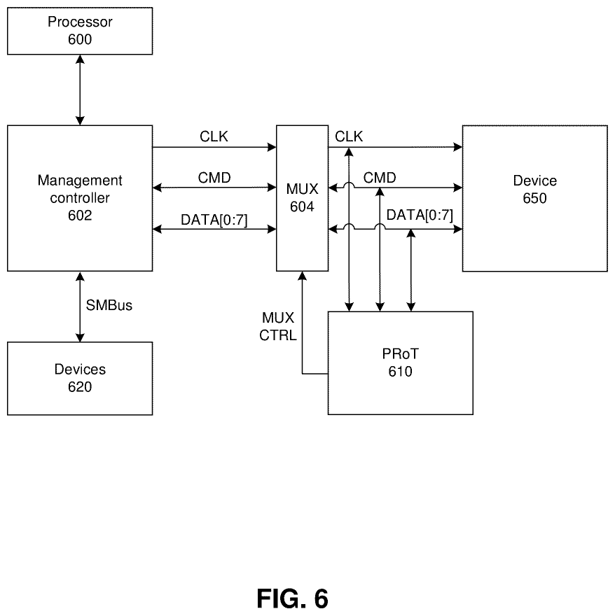

FIG. 6 depicts an example system. At boot or reset, processor 600 can request management controller 602 to provide firmware code. For example, an interface between processor 600 and management controller 602 can be consistent at least with SPI. In some examples, firmware code or firmware can include one or more of: Basic Input/Output System (BIOS), Universal Extensible Firmware Interface (UEFI), or a boot loader. The BIOS firmware can be pre-installed on a personal computer's system board or accessible through an SPI interface from a boot storage (e.g., flash memory). In some examples, firmware can include Server Platform Services (SPS).

In some examples, a Universal Extensible Firmware Interface (UEFI) can be used instead or in addition to a BIOS for booting or restarting cores or processors. UEFI is a specification that defines a software interface between an operating system and platform firmware. UEFI can read from entries from disk partitions by not just booting from a disk or storage but booting from a specific boot loader in a specific location on a specific disk or storage. UEFI can support remote diagnostics and repair of computers, even with no operating system installed. A boot loader can be written for UEFI and can be instructions that a boot code firmware can execute and the boot loader is to boot the operating system(s). A UEFI bootloader can be a bootloader capable of reading from a UEFI type firmware. A UEFI capsule is a manner of encapsulating a binary image for firmware code updates. But in some examples, the UEFI capsule is used to update a runtime component of the firmware code. The UEFI capsule can include updatable binary images with relocatable Portable Executable (PE) file format for executable or dynamic linked library (dll) files based on COFF (Common Object File Format). For example, the UEFI capsule can include executable (*.exe) files. This UEFI capsule can be deployed to a target platform as an SMM image via existing OS specific techniques (e.g., Windows Update for Azure, or LVFS for Linux).

Management controller 602 can include a processor configured to perform monitoring of server health, including temperature, fan speeds, and power status. Management controller 602 can be configured to respond to remote actions by performance of actions such as power cycling, booting, and resetting the server. Management controller 602 can provide management capabilities independent of the operating system (OS), through a dedicated management network port and can support protocols such as Intelligent Platform Management Interface (IPMI) and Redfish. Management controller 602 can provide telemetry and crash data for troubleshooting and proactive maintenance. Management controller 602 can be used to automate the initial setup and firmware updates for servers. Management controller 602 can connect to the server's hardware and provide an interface, via a network port, for management software to interact with. An example management controller 602 can include Baseboard Management Controller (BMC) from Intel®, a specialized microcontroller on server motherboards that allows for remote monitoring and management of the hardware.

Management controller 602 can stream firmware to multiple devices including processor 600, devices 620, or other devices. Management controller 602 can read firmware from device 650. For example, management controller 602 can request device 650 to read firmware from a particular address in memory of device 650. Multiplexer (MUX) 604 can selectively transfer signals from management controller 602 to device 650 based on a control signal MUX CTRL from PRoT 610. In some examples, management controller 602 can issue messages that are consistent with eMMC or other standards. For example, messages can be transmitted over CMD and DATA lines. In some examples, device 650 can include one or more of: an eMMC device, memory device, storage device, accelerator, or other device.

PRoT 610 can snoop commands transmitted over CMD lines to device 650. PRoT 610 can selectively block an entirety or less than an entirety of a message from passing MUX 604 to device 650. In some examples, PRoT 610 can replace one or more portions of a message so that device 650 does not execute a command of the message. For example, PRoT 610 can detect if a message includes a command that is not permitted to be performed by device 650, and replace an integrity check value in the message with an invalid integrity check value. Device 650 may not execute the command for having an invalid integrity check value. Accordingly, PRoT 610 can prevent device 650 from executing commands that are not permitted. Note that other examples can be utilized. For example, PRoT 610 and management controller 602 could be connected as inputs to MUX 604, host 600 may not route commands through management controller 602 to device 650, PRoT 610 could be placed between management controller 602 and device 650 and PRoT 610 could implement operations of the MUX, or others.

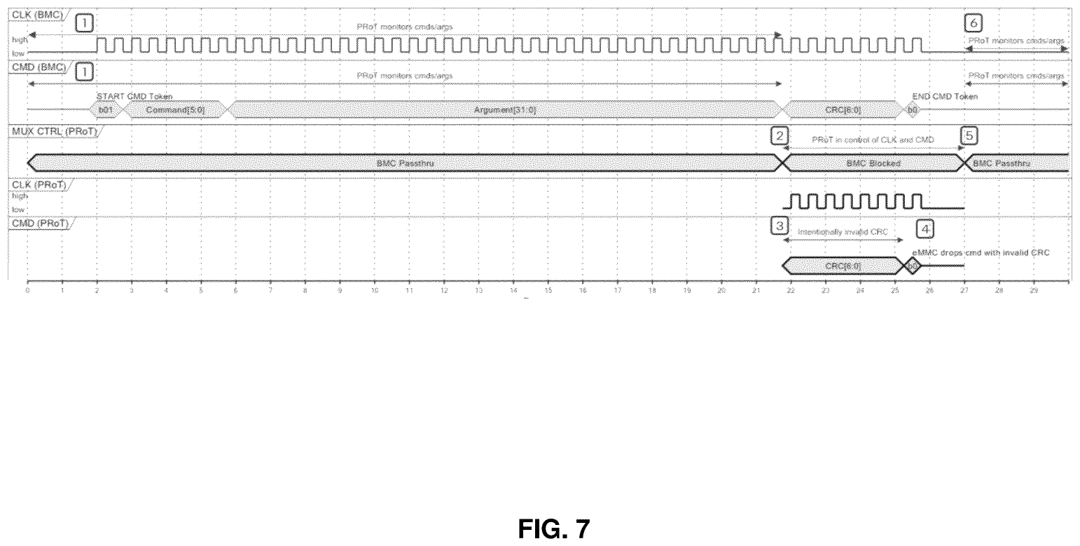

FIG. 7 depicts an example operation. At (1), PRoT monitors a bus for commands and command arguments that are to be blocked. Commands can be blocked for being on an operation block list (e.g., erases, accesses to specific memory addresses, or others). At (2), based on detection of a command that is to be blocked, such as by reading content of the command, PRoT can controls the MUX to disconnect the signal lines (e.g., CLK, CMD, Data) from the device after the last bit of the command arguments is clocked-in. At (3), PRoT can calculate and inject an invalid integrity check value for transfer with the message to the device. At (4), the device does not execute the command because the integrity check value is invalid. In some cases, the eMMC specifications do not address the behavior of a truncated command token and dropping a message and leaving a truncated command token may disrupt communications between the host and device and allow an attacker an opportunity to inject a message sent to the receiver that performs unauthorized actions. At (5), after the message with the invalid integrity value is processed by the device, PRoT can control the MUX to reconnect the host to the device. At (6), PRoT can resume monitoring the bus for commands that are to be blocked. While examples are described with respect to use of a PRoT to monitor and modify unpermitted commands that are not to be executed by a device, other examples can include a management controller.

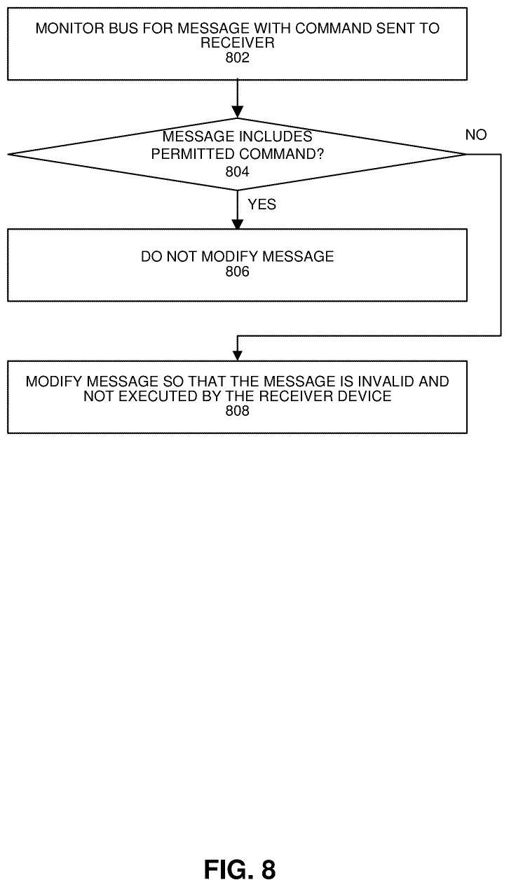

FIG. 8 depicts an example process. The process can be performed by a monitor circuitry such as a PRoT, management controller, multiplexer, host system processor-executed software or circuitry, or receiver processor-executed software or circuitry. At 802, a message can be received both by the monitor circuitry and the receiver device. In some examples, the monitor circuitry can monitor the message as the message is received by the receiver device. In some examples, the message can include a command with an integrity check value calculated over a portion of the message and used by a receiver device to determine whether to execute the command. At 804, a determination can be made as to whether the message includes a command is permitted to be executed by a receiver device. Based on the command being permitted to be executed by a receiver device, at 806, the message may not be modified for execution by the receiver device. The monitor circuitry may permit the receiver device to receive the message, unmodified, in its entirety. Based on the command not being permitted to be executed by a receiver device, at 808, an integrity check value in the message can be modified to be invalid so that the receiver device does not execute the command. For example, monitor circuitry can disconnect a bus from a sender of the message so that the sender is not able to send a portion of the message through the bus and the monitor circuitry can provide a modified portion of the message to the receiver. In some examples, other portions of the message can be modified so that the integrity check value is invalid for the message.

FIG. 9 depicts a system. The system can use examples described herein to prevent execution of invalid commands by a receiver device by modifying a portion of the commands, as described herein. System 900 includes processor 910, which provides processing, operation management, and execution of instructions for system 900. Processor 910 can include any type of microprocessor, central processing unit (CPU), graphics processing unit (GPU), processing core, or other processing hardware to provide processing for system 900, or a combination of processors. Processor 910 controls the overall operation of system 900, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 900 includes interface 912 coupled to processor 910, which can represent a higher speed interface or a high throughput interface for system components that need higher bandwidth connections, such as memory subsystem 920 or graphics interface components 940, or accelerators 942. Interface 912 represents an interface circuit, which can be a standalone component or integrated onto a processor die.

Accelerators 942 can be a fixed function or programmable offload engine that can be accessed or used by a processor 910. For example, an accelerator among accelerators 942 can provide data compression (DC) capability, cryptography services such as public key encryption (PKE), cipher, hash/authentication capabilities, decryption, or other capabilities or services. In some cases, accelerators 942 can be integrated into a CPU socket (e.g., a connector to a motherboard or circuit board that includes a CPU and provides an electrical interface with the CPU). For example, accelerators 942 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs) or programmable logic devices (PLDs). Accelerators 942 can provide multiple neural networks, CPUs, processor cores, general purpose graphics processing units, or graphics processing units can be made available for use by artificial intelligence (AI) or machine learning (ML) models. For example, the AI model can use or include one or more of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 920 represents the main memory of system 900 and provides storage for code to be executed by processor 910, or data values to be used in executing a routine. Memory subsystem 920 can include one or more memory devices 930 such as read-only memory (ROM), flash memory, one or more varieties of random access memory (RAM) such as static random-access memory (SRAM), dynamic random-access memory (DRAM), or other memory devices, or a combination of such devices. Memory 930 stores and hosts, among other things, operating system (OS) 932 to provide a software platform for execution of instructions in system 900. Additionally, applications 934 can execute on the software platform of OS 932 from memory 930. Applications 934 represent programs that have their own operational logic to perform execution of one or more functions. Processes 936 represent agents or routines that provide auxiliary functions to OS 932 or one or more applications 934 or a combination. OS 932, applications 934, and processes 936 provide software logic to provide functions for system 900. In one example, memory subsystem 920 includes memory controller 922, which is a memory controller to generate and issue commands to memory 930. It will be understood that memory controller 922 could be a physical part of processor 910 or a physical part of interface 912. For example, memory controller 922 can be an integrated memory controller, integrated onto a circuit with processor 910.

In some examples, OS 932 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a CPU sold or designed by Intel®, ARM®, AMD®, Qualcomm®, IBM®, Texas Instruments®, among others.

While not specifically illustrated, it will be understood that system 900 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 900 includes interface 914, which can be coupled to interface 912. In one example, interface 914 represents an interface circuit, which can include standalone components and integrated circuitry. In one example, multiple user interface components or peripheral components, or both, couple to interface 914. Network interface 950 provides system 900 the ability to communicate with remote devices (e.g., servers or other computing devices) over one or more networks. In some examples, network interface 950 can refer to one or more of: a network interface controller (NIC), a remote direct memory access (RDMA)-enabled NIC, SmartNIC, router, switch, forwarding element, infrastructure processing unit (IPU), data processing unit (DPU), or network-attached appliance.

Network interface 950 can include an Ethernet adapter, wireless interconnection components, cellular network interconnection components, USB (universal serial bus), or other wired or wireless standards-based or proprietary interfaces. Network interface 950 can transmit data to a device that is in the same data center or rack or a remote device, which can include sending data stored in memory.

Some examples of network interface 950 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable pipelines or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Some examples of network interface 950 can include a programmable packet processing pipeline with one or multiple consecutive stages of match-action circuitry. The programmable packet processing pipeline can be programmed using one or more of: Protocol-independent Packet Processors (P4), Software for Open Networking in the Cloud (SONiC), Broadcom® Network Programming Language (NPL), NVIDIA® CUDA®, NVIDIA® DOCA™ Data Plane Development Kit (DPDK), OpenDataPlane (ODP), Infrastructure Programmer Development Kit (IPDK), x86 compatible executable binaries or other executable binaries, or others.

In one example, system 900 includes one or more input/output (I/O) interface(s) 960. I/O interface 960 can include one or more interface components through which a user interacts with system 900 (e.g., audio, alphanumeric, tactile/touch, or other interfacing). Peripheral interface 970 can include any hardware interface not specifically mentioned above. Peripherals refer generally to devices that connect dependently to system 900. A dependent connection is one where system 900 provides the software platform or hardware platform or both on which operation executes, and with which a user interacts.

In one example, system 900 includes storage subsystem 980 to store data in a nonvolatile manner. In one example, in certain system implementations, at least certain components of storage 980 can overlap with components of memory subsystem 920. Storage subsystem 980 includes storage device(s) 984, which can be or include any conventional medium for storing large amounts of data in a nonvolatile manner, such as one or more magnetic, solid state, or optical based disks, or a combination. Storage 984 holds code or instructions and data 986 in a persistent state (e.g., the value is retained despite interruption of power to system 900). Storage 984 can be generically considered to be a “memory,” although memory 930 is typically the executing or operating memory to provide instructions to processor 910. Whereas storage 984 is nonvolatile, memory 930 can include volatile memory (e.g., the value or state of the data is indeterminate if power is interrupted to system 900). In one example, storage subsystem 980 includes controller 982 to interface with storage 984. In one example controller 982 is a physical part of interface 914 or processor 910 or can include circuits or logic in both processor 910 and interface 914.

A volatile memory is memory whose state (and therefore the data stored in it) is indeterminate if power is interrupted to the device. A non-volatile memory (NVM) device is a memory whose state is determinate even if power is interrupted to the device.

PRoT 990 can be connected to interface 914 to monitor command tokens from processor 910 to storage subsystem 980. As described herein, PRoT 990 can read command tokens from interface 914 to determine whether command is permitted to be executed by storage subsystem 980 (or other device) or not permitted to be executed by storage subsystem 980 (or other device).

Management controller (MC) 992 can be coupled to interface 914, interface 912, or other devices or interfaces. Management controller 992 can include a processor configured to perform monitoring of server health, including temperature, fan speeds, and power status.

In an example, system 900 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe.

Communications between devices can take place using a network, interconnect, or circuitry that provides chipset-to-chipset communications, die-to-die communications, packet-based communications, communications over a device interface (e.g., PCIe, CXL, UPI, or others), fabric-based communications, and so forth. A die-to-die communications can be consistent with Embedded Multi-Die Interconnect Bridge (EMIB).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner, or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal (e.g., active-low or active-high). The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.′”

Illustrative examples of the devices, systems, and methods disclosed herein are provided below. An embodiment of the devices, systems, and methods may include any one or more, and any combination of, the examples described below.

Example 1 includes one or more later examples and includes an apparatus that includes: an interface and Root of Trust (RoT) circuitry to: monitor a bus for a particular message and based on detection of the particular message, replace the particular message with an invalid portion and provide the invalid portion to a receiver, wherein the particular message comprises a command and wherein the receiver comprises an Embedded Multi-Media Card (eMMC).

Example 2 includes one or more earlier or later examples, wherein the circuitry comprises a platform root of trust (PRoT), a management controller, a multiplexer, or a host system.

Example 3 includes one or more earlier or later examples, wherein to replace the particular command with the invalid command, the circuitry is to disconnect a sender from the bus and replace an integrity value of the command with an invalid integrity value.

Example 4 includes one or more earlier or later examples, wherein the particular command comprises an access to a particular memory address or an unpermitted operation.

Example 5 includes one or more earlier or later examples, wherein the receiver comprises a firmware storage device.

Example 6 includes one or more earlier or later examples, wherein the bus is consistent with JESD84-B51 (2020).

Example 7 includes one or more earlier or later examples, and includes a method comprising: receiving, at an Embedded Multi-Media Card (eMMC), a first command and a second command; based on a first integrity check value for the first command being valid, executing the first command; and based on a second integrity check value for the second command being invalid, not executing the second command, wherein the second integrity check value comprises an integrity check value modified by a monitor device that caused the second command to not be executed.

Example 8 includes one or more earlier or later examples, wherein the second command comprises a command that is not permitted to be executed by a receiver according to a watch list configuration.

Example 9 includes one or more earlier or later examples, wherein the second command comprises an access to a particular memory address or an unpermitted operation.

Example 10 includes one or more earlier or later examples, wherein the monitor device comprises a platform root of trust (PRoT), multiplexer, or management controller.

Example 11 includes one or more earlier or later examples, and includes disconnecting, by a multiplexer, a sender from a bus; replacing, by the monitor device, the second integrity check value with an invalid integrity check value; and providing, by the monitor device, the second command with the invalid integrity check value.

Example 12 includes one or more earlier or later examples, wherein a receiver of the first and second commands comprises a firmware storage device.

Example 13 includes one or more earlier or later examples, and includes receiving the first and second commands on a bus consistent with JESD84-B51 (2020).

Example 14 includes one or more earlier or later examples, and includes at least one non-transitory computer-readable medium comprising instructions stored thereon, that if executed by one or more processors, cause the one or more processors to: configure a circuitry to: monitor a bus for a first message and based on detection of the first message, replace the first message with an invalid portion and provide the invalid portion to a receiver, wherein the first message comprises a command and wherein the receiver comprises an Embedded Multi-Media Card (eMMC).

Example 15 includes one or more earlier or later examples, comprising instructions stored thereon, that if executed by one or more processors, cause the one or more processors to: permit a second message to be received by the receiver without modification of an integrity check value of the second message.

Example 16 includes one or more earlier or later examples, wherein the replace the first message with an invalid portion and provide the invalid portion to a receiver comprises: configure a multiplexer to disconnect a sender from a bus, replace an integrity check value of the first message with an invalid integrity check value, and provide the first message with the invalid integrity check value to the receiver.

Example 17 includes one or more earlier or later examples, wherein the first message comprises an access to a particular memory address or an unpermitted operation.

Example 18 includes one or more earlier examples, comprising instructions stored thereon, that if executed by one or more processors, cause the one or more processors to: provide the first message with the invalid portion to the receiver on a bus consistent with JESD84-B51 (2020).

1. An apparatus comprising:
an interface and
a root of trust (RoT) circuitry to:
monitor a bus for a particular message and based on detection of the particular message, replace the particular message with an invalid portion and provide the invalid portion to a receiver, wherein the particular message comprises a command and wherein the receiver comprises an Embedded Multi-Media Card (eMMC).

2. The apparatus of claim 1, wherein the RoT circuitry comprises a management controller, a multiplexer, or a host system.

3. The apparatus of claim 1, wherein to replace the particular command with the invalid command, the RoT circuitry is to disconnect a sender from the bus and replace an integrity value of the command with an invalid integrity value.

4. The apparatus of claim 1, wherein the particular command comprises an access to a particular memory address or an unpermitted operation.

5. The apparatus of claim 1, wherein the receiver comprises a firmware storage device.

6. The apparatus of claim 1, wherein the bus is consistent with JESD84-B51 (2020).

7. A method comprising:
receiving, at an Embedded Multi-Media Card (eMMC), a first command and a second command;
based on a first integrity check value for the first command being valid, executing the first command; and
based on a second integrity check value for the second command being invalid, not executing the second command, wherein the second integrity check value comprises an integrity check value modified by a monitor device that caused the second command to not be executed and wherein the monitor device comprises a root of trust (RoT).

8. The method of claim 7, wherein:
the second command comprises a command that is not permitted to be executed by a receiver according to a watch list configuration.

9. The method of claim 7, wherein:
the second command comprises an access to a particular memory address or an unpermitted operation.

10. The method of claim 7, wherein the monitor device comprises a platform root of trust (PRoT), multiplexer, or management controller.

11. The method of claim 7, comprising:
disconnecting, by a multiplexer, a sender from a bus;
replacing, by the monitor device, the second integrity check value with an invalid integrity check value; and
providing, by the monitor device, the second command with the invalid integrity check value.

12. The method of claim 7, wherein a receiver of the first and second commands comprises a firmware storage device.

13. The method of claim 7, comprising:
receiving the first and second commands on a bus consistent with JESD84-B51 (2020).

14. At least one non-transitory computer-readable medium comprising instructions stored thereon, that if executed by one or more processors, cause the one or more processors to:
configure a root of trust (RoT) circuitry to:
monitor a bus for a first message and based on detection of the first message, replace the first message with an invalid portion and provide the invalid portion to a receiver, wherein the first message comprises a command and wherein the receiver comprises an Embedded Multi-Media Card (eMMC).

15. The non-transitory computer-readable medium of claim 14, comprising instructions stored thereon, that if executed by one or more processors, cause the one or more processors to:
permit a second message to be received by the receiver without modification of an integrity check value of the second message.

16. The non-transitory computer-readable medium of claim 14, wherein the replace the first message with an invalid portion and provide the invalid portion to a receiver comprises:
configure a multiplexer to disconnect a sender from a bus,
replace an integrity check value of the first message with an invalid integrity check value, and
provide the first message with the invalid integrity check value to the receiver.

17. The non-transitory computer-readable medium of claim 14, wherein:
the first message comprises an access to a particular memory address or an unpermitted operation.

18. The non-transitory computer-readable medium of claim 14, comprising instructions stored thereon, that if executed by one or more processors, cause the one or more processors to:
provide the first message with the invalid portion to the receiver on a bus consistent with JESD84-B51 (2020).
